(19) United States
(12) Patent Application Publication
(10) Pub. No.: US 2006/0048062 A1
(43) Pub. Date: Mar. 2, 2006

(54) Software and method providing graphic user interface for graphics adapter configuration

(76) Inventor: Dale F. Adamson, Aurora (CA)

Correspondence Address: SMART AND BIGGAR, 438 UNIVERSITY AVENUE, SUITE 1500 BOX 111, TORONTO, ON, M5G2K8, CA

(21) Appl. No.: 10/930,827

(22) Filed: Sep. 1, 2004

(51) Int. Cl. G06F 17/00

(52) U.S. Cl. 715/760; 715/810; 715/835

(57) ABSTRACT

A graphical user interface has a drag-and-drop region used to activate one or more display devices interconnected with a graphics adapter. Display devices interconnected with a graphic adapter may be activated by a user dragging-and-dropping icons representing the display devices. If multiple adapter configurations reflecting icons as dragged-and-dropped are allowed, the user may be presented with multiple configuration options. Adapter configuration may also optionally be controlled by clicking icons already within the drag-and-drop regions.

### FIELD OF THE INVENTION

The present invention relates generally to computing devices and software, and more particularly to software for configuring graphics adapters, and related methods.

### BACKGROUND OF THE INVENTION

Computer graphics adapters including special purpose computer graphics processors have become standard equipment in most computing devices. Over the years the complexity has increased steadily. Each new graphics adapter seemingly provides one or more new features not previously available.

For example, in the past decade, graphics adapters that allow video to be presented on two or more display devices have become commonplace.

While providing benefits to end-users, all the new features also increase the complexity of operation and configuration of the adapters. Fortunately, adapters are configured through software executing in a graphical user environment, such as the environment presented by the Microsoft Windows operating systems Such software can simplify configuration greatly.

However, there is always a need for new software and methods that further simplify configuration of display adapters.

### SUMMARY OF THE INVENTION

Accordingly, a graphical user interface has a drag-and-drop region used to activate one or more display devices interconnected with a graphics adapter. Display devices interconnected with a graphic adapter may be activated by a user dragging-and-dropping icons representing the display devices. If multiple adapter configurations reflecting icons as dragged and dropped are allowable, the user may be presented with multiple configuration options. Adapter configuration may also optionally be controlled by interacting with icons (e.g. clicking) already within the drag-and-drop regions.

In accordance with an aspect of the invention, there is provided in a computing device a method of configuring a graphics adapter, including: presenting a graphical user interface including first and second drag-and-drop regions; populating said first and second drag-and-drop regions with icons reflecting display devices interconnected with said graphics adapter, and active, with said first drag-and-drop region reflecting a first display device; and presenting a plurality of additional icons, each additional icon representing an additional display device interconnected with said graphics adapter. There is also provided a method of configuring a graphics adapter, including: sensing user interaction dragging-and-dropping a selected one of said plurality of additional icons into said second drag-and-drop region; and in response to said dragging-and-dropping, determining allowable configurations of said graphics adapter with said first display device active and a second display device as represented by said selected one of said plurality of additional icons, active.

In accordance with another aspect of the present invention, there is provided a computing device including at least two display devices interconnected with a graphics adapter, and a graphical user interface for configuring said graphics adapter, said graphical user interface comprising: an adapter control area, including first and second drag-and-drop regions populated with icons reflecting display devices interconnected with said graphics adapter, and active, with said first drag-and-drop region reflecting a first display device; and a plurality of additional icons, each additional icon representing an additional display device interconnected with said graphics adapter. There is also provided a computing device including said first and second drag-and-drop area responsive to a user dragging-and-dropping a selected one of said plurality of additional icons into said first or second drag-and-drop region, to re-configure said adapter to provide outputs to said display devices, as represented by icons dragged-and-dropped from said additional icons in said first and second drag-and-drop regions.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In figures which illustrate by way of example only, embodiments of the present invention,

FIG. 1 is a block schematic diagram of a computing device exemplary executing graphics adapter configuration software exemplary of an embodiment of the present invention;

FIG. 2 is a block diagram illustrating software components at the device of FIG. 1;

FIG. 3 is a screen capture of a graphical user interface presented by the software of the device FIG. 1, for configuring graphics adapters, exemplary of an embodiment of the present invention;

FIG. 4 illustrate example icons representing modes of operation of adapters of the device of FIG. 1;

FIG. 5 illustrates example icons representing display devices interconnected with the device of FIG. 1; and

FIG. 6A-D are screen captures of a portion of the graphical user interface if FIG. 3 in use.

### DETAILED DESCRIPTION

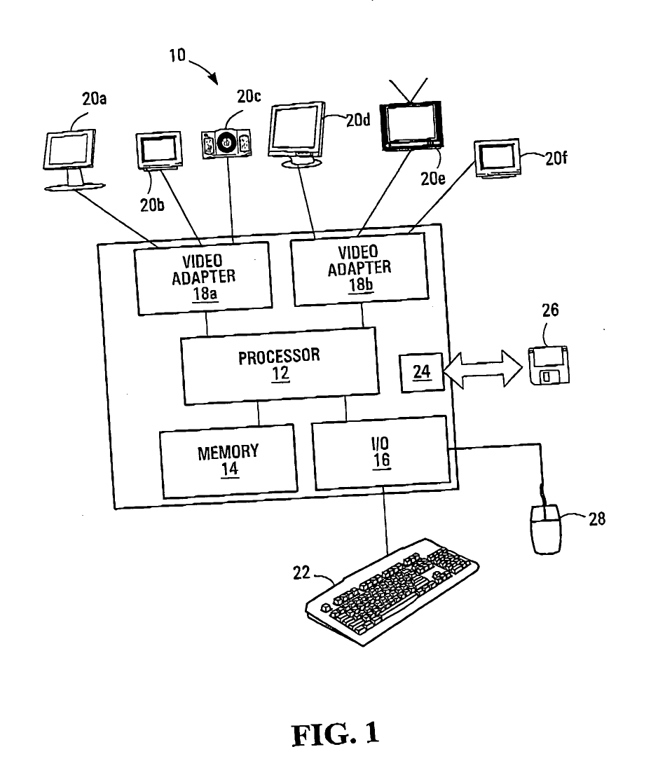

FIG. 1 illustrates a computing device 10 including software, adapting device 10 to operate in manners exemplary of embodiments of the present invention. Exemplary device 10 is a conventional computing device, executing a conventional operating system providing a graphical computing environment, and applications that make use of the operating system and graphical operating environment, as detailed below. Device 10 includes a processor 12 in communication with computer memory 14, input/output interface 16, graphics adapters 18a and 18b (individually and collectively adapters 18) and display devices 20a, 20b, 20c, 20d, 20e and 20f (individually and collectively display devices 20). Device 10 may optionally include peripheral devices such as keyboard 22, disk drive 24, mouse 28 and the like. As well, device 10 may include one or more network interfaces and other computer peripherals known to those of ordinary skill.

In the depicted embodiment, computing device 10 executes a Microsoft Windows™ operating system. For example, device 10 may execute Windows XP; Windows NT 4.0, Windows ME; Windows 98, Windows 2000, Windows 95. As will become apparent, software exemplary of embodiments of the present invention could be suitably implemented in another graphical computing environment, such as a Unix based X-Windows environment or MacOS computing environment. Processor 12 in exemplary computing device 10 is a conventional central processing unit and may for example be a microprocessor compatible with the INTEL™ x86 family of microprocessors Computer memory 14 includes a suitable combination of random access memory, read-only memory and disk storage memory, used by device 10 to store and execute operating system and application software programs adapting device 10 in manners exemplary of the embodiments of the present invention. Exemplary software could, for example, be stored in read-only memory or loaded from an external peripheral such as drive 24, capable of reading and writing data to or from a computer readable medium 26 used to store software to be loaded into memory 14. Computer readable medium 26 may be an optical storage medium, a magnetic diskette, tape, ROM cartridge or the like.

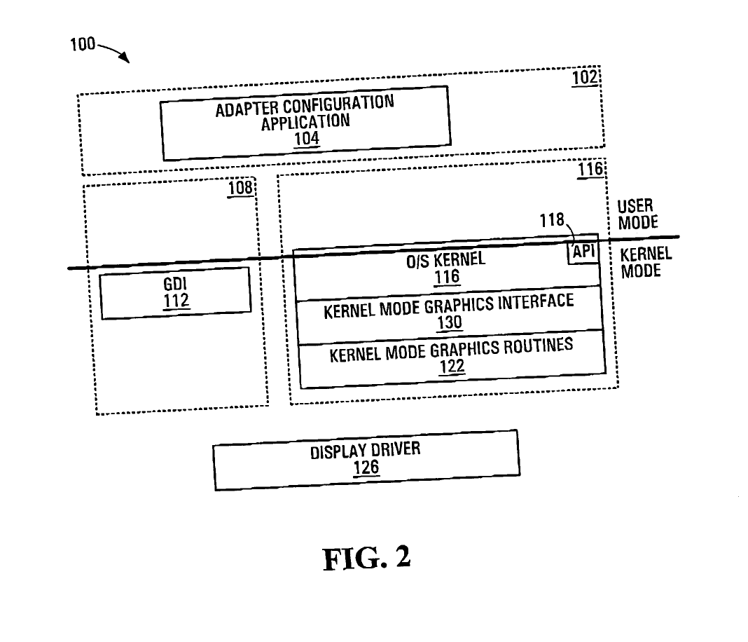

Selected components of software 100 stored within memory 14 during execution are illustrated in FIG. 2. Software 100 includes application software 102; graphics program modules 108; and operating system 116. As illustrated, the arrangement of application software 102 and operating system 116 is layered. In this architecture, layers with higher levels of abstraction can utilize the software routines provided by layers implemented below them which provide more specificity to implement certain services.

Software 100 takes advantage of hardware memory protection features of processor 12. As such, depicted software components when executed by processor 12 execute in one of two processor modes. One mode (referred to in the Windows programming environment as a “user mode” or “Ring 3”) has access to limited CPU memory address spaces. The other mode (referred to as “kernel mode” or “protected mode” or “Ring 0”) has uninhibited access to the CPU memory address space, and hardware devices. For ease of illustration, software executing in user and kernel mode are delineated in FIG. 2. As illustrated, certain portions of operating system 116 are executed in kernel mode 120. Applications software 102 and certain modules 108 and portions of operating system 116 that may make use of the portions of the operating system 116 executing in kernel mode can be executed in user mode. Access to protected hardware and memory may be gained by the applications by making appropriate operating system calls, using the operating system API 118 or calls to kernel mode modules. In response, software executing in kernel mode makes the restricted memory/hardware access.

Graphics program modules 108 may, for example, be user or kernel mode graphics libraries, and may be dynamically linked libraries linked to individual applications of application software 102, as required. Example graphics modules 108 may include a user mode Graphics Driver Interface (GDI) library 112, Microsoft's DirectX library, Microsoft's, or the OpenGL library (not shown). For user mode libraries, complementary kernel mode graphics routines 122 to the user mode libraries may be accessible through kernel mode graphics interface 130. As will be appreciated, graphics program modules 108 provide data structures and routines that facilitate the presentation of certain graphics by graphics adapters 18.

GDI library 112 provides a GDI API 124 allowing user applications to present basic, typically two-dimensional, graphical displays using low level hardware, such as a graphics adapters 18. As well, GDI library 112 allows programming of graphical drag-and-drop user interfaces. As will be appreciated by those of ordinary skill, “drag-and-rop” methods allow manipulation of on-screen objects such as text, icons or graphics in a graphical user interface or similar environment. A user selects an icon, filename or other object by moving a cursor using mouse 28 and holds a button down while “dragging” the cursor and the “attached” object to another part of the display, which might be an icon for an application program, or merely a new location for the object (as in a word-processor). The object is dropped from the cursor by releasing the button of mouse 28. The meaning of this action may be modified by simultaneously pressing certain keys. Programming using drag-and-drop in the Windows Microsoft environment is more particularly described in http://msdn.microsoft.com/library/default.asp?url=/library/en-us/vbcon/html/vbtskstartingdragoperations.asp.

Now, depicted device 10 includes multiple adapters 18 capable of providing video output to two physical displays 20a-20e. In the depicted embodiment device 10 includes only two adapters 18a and 18b, with three display devices 20a, 20b and 20c associated with adapter 18a and three possible display devices 20d, 20e and 20f associated with adapter 18b. In the depicted embodiment, display devices 20a, 20b and 20c are respectively an LCD display, analog monitor and projector; devices 20d, 20e and 20f are respectively an LCD display, TV, and analog monitor.

Each adapter 18 accordingly includes a graphics processor and one or more independent display paths and associated hardware each for driving one or more displays. Hardware used to drive independent display devices 20 may include transmission minimized differential signalling (TMDS) transmitters, CRT and TV digital to analog converters, and the like. Each adapter 18 accordingly may further include one or more output ports, one for each interconnected display device 20. Adapters 18 may be configured through driver 126. Hardware on adapters 18 may be configured to control which ports are active, and which images are presented at each port. Example graphics adapters providing a single independent display path, with multiple output ports include ATI's RADEON™ 7200 graphics adapters. Example graphics adapters having multiple display paths include ATI's RADEON™ 9700 and RADEON™ 9800 graphics adapters.

As will be appreciated, the configuration of adapters 18 is exemplary only. Software 104 may be used with a variety of adapters and devices from numerous manufacturers. Software 104 may be used to configure one adapter or an arbitrary number of adapters and attached display devices, including one or more independent graphics paths.

An adapter with only a single display path uses one frame buffer to provide identical output to one or more interconnected display devices 20. Each interconnected display device 20 could, for example, be a CRT (monitor), a standard TV, a digital flat panel display (FPD), an HDTV, a projector, or an LCD (laptop panel). Resolution, refresh rate, and colour depth for all display devices is identical and limited by the least-capable display device. The same source image appears on all such display devices. However, some adapters with appropriate software may allow panning, thus allowing a large source image to be displayed on low-resolution display device, such as a TV, by panning the screen area on that device. Timing and hardware restrictions dictate that only certain display types can be driven by the same display path.

Some adapters providing two display paths, including ATI's RADEON™ 9800 XT, RADEON™ 9700 adapters, allow each display path to access the same frame buffer and provide output to a variety of display devices. Output to each of the interconnected display devices originates with the same frame buffer, but may be the same or vary. The different outputs may be interrelated, so that they appear as part of larger vertical or horizontal display area, or within a virtual display area. The dual display paths are independent so that certain settings, such as refresh rate, colour depth and the like, may be completely different on the different interconnected display devices. In one mode, (later described as a “clone mode”) the same source image within the frame buffer appears on all display devices. In the case of vertical and horizontal stretch modes, the source image in the frame buffer is split between the two display paths that drive the display devices, so that each display shows one-half of the desktop. With only a single frame buffer, the operating system 116 treats the combined displays as one large logical desktop.

Other, adapters having two asynchronous display paths with two different frame buffers, in the operating system's native extended desktop mode. In this mode, the operating system sees the second display path as a separate display adapter, with its own source image in a virtual desktop, Resolution, refresh rate, colour depth and source image can be different on display devices that are mapped to the different display paths.

When multiple adapters 18 are enabled in computing device 10 operating system 116 typically uses a separate driver 126, or separate instance of the same driver 126 for each adapter 18.

To summarize possible desktop modes for each graphics adapter 18, include:
Single Display: only one display device 20 is active on one adapter 18.
Clone Mode: two display devices 20 are active on an adapter 18, one mapped to each of two display paths, the two display devices show the identical desktop (i.e., the same frame buffer); the resolution and colour depth will be identical for both, but the refresh rate can be set individually.
Horizontal stretch: two display devices 20 are active on an adapter 18, but use a single frame buffer and are treated as a single large desktop; the desktop area is spread horizontally across both displays, and operating system 116 treats both displays as one large display; operating system 116 need not even be aware that two displays are enabled; the desktop area is the combined area of both displays, and the colour depth on both displays will be identical.
Vertical Stretch: similar to horizontal stretch with two display devices 20 active but using a single frame buffer and treated as a single large desktop; the desktop area is spread vertically across both displays devices; the operating system treats both display devices as one large display and the colour depth on both display devices will be identical.
Doubled-up mode: two display devices 20 are active using the same display path and frame buffer, the desktop area, refresh rate, and colour depth on both displays are identical; the available range for each of these parameters will typically be restricted by the least-capable display device. (e.g. if an NTSC TV and analog monitor are doubled-up, both display devices will be restricted to a refresh rate of 60 Hz).
Extended Desktop: two display devices 20 are active, one is mapped to each of the two display paths on one adapter 18; or to two display paths on two separate adapters 18; each display path is associated with a separate driver 126 and frame buffer, and shows a different section of an extended desktop; each display can have an independent colour depth and refresh rate and, can be arranged to any shape, with each desktop having a different resolution; each display can also be independently rotated.

Which of the above desktop modes will be supported by each adapter 18 will depend on the specific types of adapters used in device 10, and interconnected display devices 20.

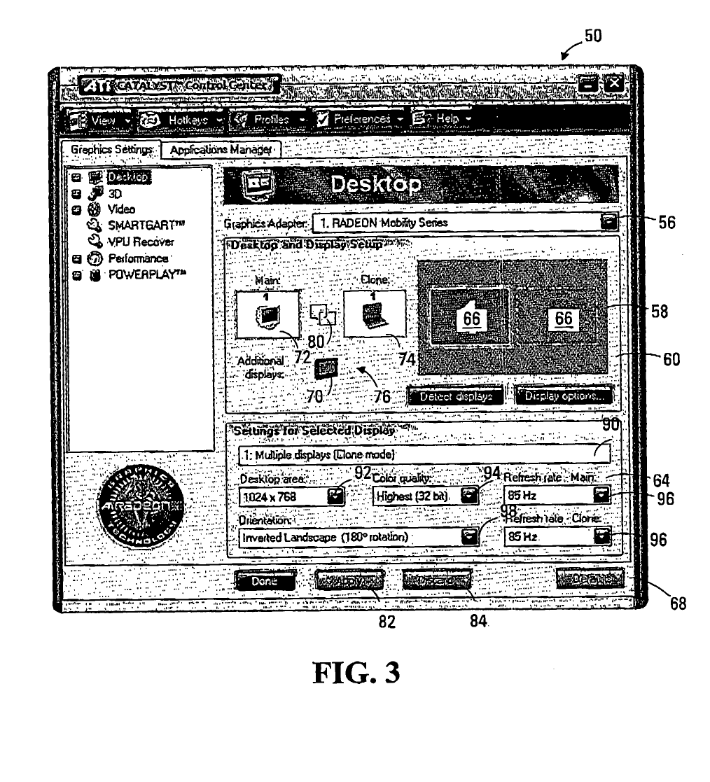

In order to configure adapters 18 in one of the myriad of possible modes, adapter configuration software 104 exemplary of an embodiment of the present invention, presents a simplified graphical user interface (“GUI”) exemplified by GUI 50, depicted in FIG. 3. GUI 50 provides an end-user extensive control over display devices 20, and associated configurations of adapters 18.

GUI 50 is drawn using conventional graphics libraries. In the depicted embodiment, GUI 50 is drawn by adapter configuration software 104 using GDI library 112. Adapter configuration software 104 may make suitable calls to operating system 116 or to driver 126 to query abilities of adapters 18, and interconnected displays 20, or change settings of adapters 18.

GUI 50 includes four regions of interest: dropdown list 56; adapter control area 60; display control area 64; and dialog interaction area 68.

In operation, software 104 initially queries driver 126 and operating system 116 to assess interconnected adapters 18, their configuration, and interconnected displays. Specifically, software 104 directly or through an intermediate software module (not illustrated) queries driver 126 for the capabilities of interconnected adapters 18 and display devices 20. Driver 126, in turn generates a list of possible configurations for each adapter, based on the adapter type 18 and interconnected display devices 20. If the driver cannot provide the required information about supported configurations application 104 will treat that adapter 18 as having only a single supported configuration, with a single display path and display device 20. Driver 126 may provide the current adapter ID, permissible active displays devices and associated resolutions, colour depths, orientations and refresh rate. For example, in the Windows™ environment, operating system API 116 may be used to query for information. Driver 126 generates a data structure used by application 104 to refresh GUI 50.

Using information about current and allowable configurations of adapters 18, software 104 draws GUI 50 as illustrated in FIG. 3 using a suitable graphics library (such as GDI library 112). Once drawn, software 104 senses end-user interaction with GUI 50. Changes made through GUI 50 may be committed or discarded by clicking APPLY or DISCARD buttons 82, 84 in dialog interaction area 68. Software 104, in turn applies configuration changes through driver(s) 126 reflecting configuration changes to adapters 18, and refreshes GUI 50 to reflect changes in configuration.

As illustrated, in FIG. 3, dropdown list 56 is populated with text entries identifying each adapter 18 recognized by operating system 116. If there is more than one graphics adapter, adapter 18 connected to the “primary” display device is in position “1”. The primary display device will show the logon dialog box when the user starts computing device 10. In addition, games usually open on the primary display device. Similarly, most applications will display windows on the primary display when they are initially opened.

Adapter control area 60 allows a user to configure individual adapters 18 and attached display devices 20. Window 58 within area 60 graphically illustrates all interconnected display devices as recognized by the operating system 116 and their relationship to each other. Window 58 contains simplified display icons 66, in the form of rectangles that represent both active and inactive display devices 20 for all installed graphics adapters. If more than one icon 66 appears, right-clicking each icon 66 causes an “Identify” option to be presented. Selecting this option will muse software 104 to place a large number, assigned by operating system 116 to identify each display, in each icon 66. If multiple display devices 20 are capable of displaying different images, software 104 allows users to drag the icons 66 to positions within window 58 that represent a desired logical relationship of two or more display areas in an extended desktop area. For example, if two display devices 20 are in use and items are to be moved from one display to the other by dragging left and right, icons 66 may be positioned side-by-side. To move items between display devices 20 by dragging up and down, icons 66 may be positioned one above the others. That is, icons 66 can be positioned one above the other even though the displays are side-by-side, but the arrangement will determine how the cursor, and windows, and the like will move across multiple displays. Methods and software for arranging logical displays within an extended desktop are disclosed in U.S. Pat. Nos. 5,923,307 and 6,018,340.

Which of multiple adapters 18 is controlled by area 60 is dictated by which of multiple display icons 66 in window 58 has been selected by way of clicking the corresponding icon 66 or by which entry of list box 56 has been chosen. This adapter will be identified in list box 56. Adapter control area 60 includes two drag-and-drop regions 72 and 74 that also respond to right-click actions, as detailed below. Drag-and-drop regions 72, 74 typically represent primary and secondary display paths on the selected adapter 18, to which any detected display devices 20 interconnected with the adapter can be mapped in the permissible combinations.

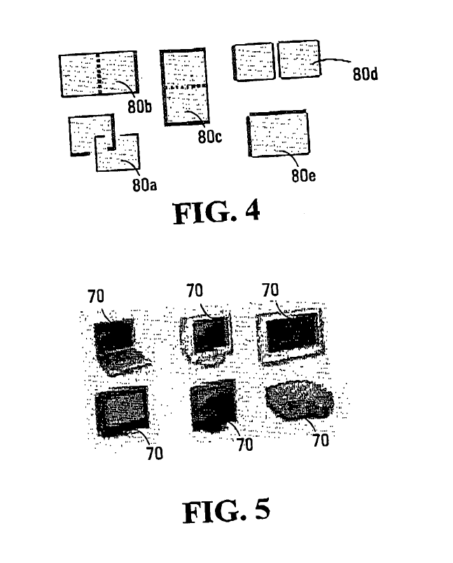

Software 104 populates regions 72 and 74 with icons 70 representing display devices 20 that are configured as active, each time GUI 50 is initially drawn or APPLY button 84 is pressed. Icon 80 between two drag-and-drop regions 72, 74 indicates the current desktop mode as one of the six possibilities, outlined above: clone mode, horizontal stretch, vertical stretch, extended desktop, single display or single display path (doubled up). The first five of these are represented by icons 80a, 80b, 80c, 80d, and 80e (individually and collectively 80), respectively, depicted in FIG. 4. The sixth mode, single-display path (doubled up), is implied when two displays occupy the occupy the same drag-and-drop region 72 or 74. No icon is depicted

Selecting an icon 70 already contained within one of drag-and-drop regions 72 and 74 in area 60 (FIG. 3) also highlights (via a change in contrast or colour) the corresponding display icon 66 in window 58 (and vice-versa). The focus will remain on whatever display icon 66 the user has clicked, and vice-versa. For example, a user uses the mouse pointer to click an icon 66 in window 58, say display “2”, the matching display device “2” is highlighted in regions 72 and 74. In the case of clone or stretch modes, more than one display device “2” would exist and be highlighted, but focus would remain on the corresponding display icon 66 in window 58.

An available displays area 76 includes icons 70 representing additional available display devices 20. Depicted icons 70 outside drag-and-drop regions 72 and 74 in area 76 reflect any attached (detected) physical display devices 20 that are interconnected, but not active, with the adapter 18 that is currently controlled by area 60.

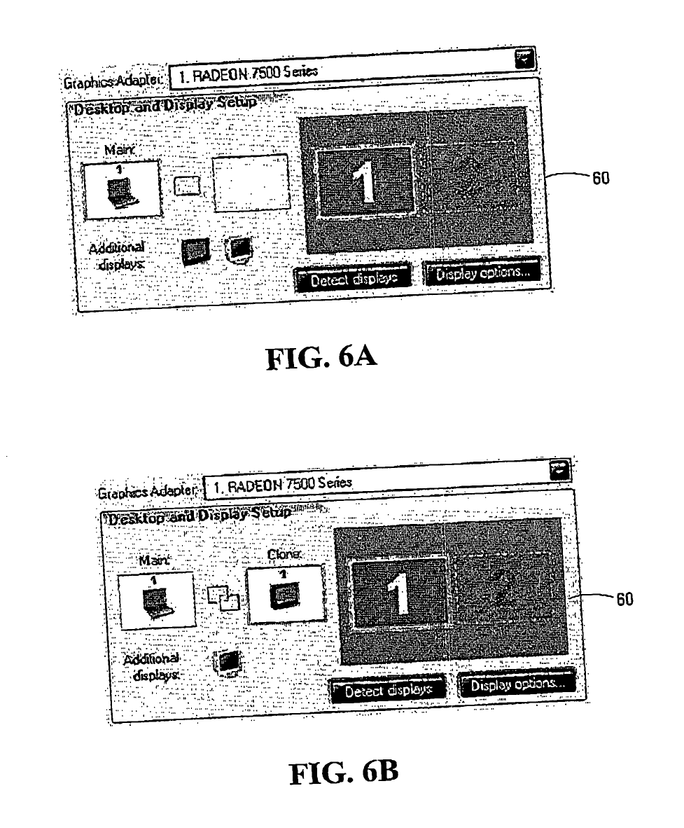

Possible exemplary display device icons 70, shown in FIG. 5, are graphical representations that users can drag-and-drop to map and unmap display devices 20 that they represent, if connected to the graphics adapter 18 currently represented by area 60. As illustrated, icons 70 may represent an LCD panel, analog monitor (CRT), HDTV (component output), projector, digital flat panel, standard TV. As some adapters can support more than one analog or digital display device, so some configurations may have repeated icons.

Conveniently, when a user points to an icon 70 in area 76, with the mouse cursor, pop-up text may provide a description of the represented device, whether it is currently mapped or unmapped. Where possible, the description is queried by software 104 from the VESA extended display identification data (“EDID”) for that device—for example, “Compaq V700”. If no EDID is available, software 104 substitutes a generic term (such as “Analog Monitor”).

Optionally, area 76 could also show, by selection of a user option, any potential but unconnected display devices that the adapter could support. For example, an icon of an HDTV device could be displayed, but grayed out, indicating that the adapter can support such a device, but it is not currently connected. However, the user would not be able to map an unconnected device to a display path (i.e., attempts to drag the device to a drag-and-drop region 72, 74) would be prohibited.

When a display icon 70 in area 60 is dragged from (i.e. out of) drag-and-drop region 72, 74 in area 60, that display becomes unmapped and output to that device is terminated by software 104 on pressing APPLY button 82. That is, dragging an icon 70 from the primary or secondary drag-and-drop region 72, 74 to the additional displays area 76, effectively disables the display device represented by the dragged icon, even though it is still physically connected to the adapter 18a or 18b. Alternately, an active display in drag-and-drop regions 72, 74 may be disabled by way of a right-click menu, as detailed below.

Dragging an icon 70 from the additional displays area 76 to the primary or secondary drag-and-drop region 72, 74, effectively enables a connected display device 20, and maps it to a specific display path. Specifically, after an icon 70 is dragged from area 76 and dropped to region 72, 74, software 104 determines allowable configurations for the adapter currently represented by area 60, with display devices reflected by icons in regions 72, 74 active, based on the list of allowable configurations obtained through driver 126. Upon releasing the mouse button, software 104 presents user choices allowing the user to choose one of the allowable desktop modes as represented by the icons 70 now in regions 72 and 74. User choices are presented by popup menus are created by software 104 according to allowable configurations for the given adapter 18 and display devices 20, and available desktop modes. If no allowable options exist the cursor will change as the user mouse curser hovers over an invalid selection. When the mouse button is released, the dragged display device icon 70 will snap back to its former position.

Conveniently, software 104 also changes labels above icons in drag-and-drop regions 72, 74 depending on the resultant desktop mode (for example, from “Clone” to “Rightmost”). For the six available desktop modes, detailed above, user-friendly labels are given to the primary and secondary drag-and-drop regions 72, 74 for each adapter 18. These labels are

| | Primary display region | Secondary display region |
|---|---|---|
| Desktop mode | 72 | 74 |
| Single display | Main, or ‘Desktop *x’ | n/a |
| Clone mode | Main | Clone |
| Horizontal stretch | Main | Rightmost |
| Vertical stretch | Main | Lower |
| Extended desktop | Desktop *1 | Desktop *2 |
| Doubled-up | Main, or ‘Desktop *x’ | |

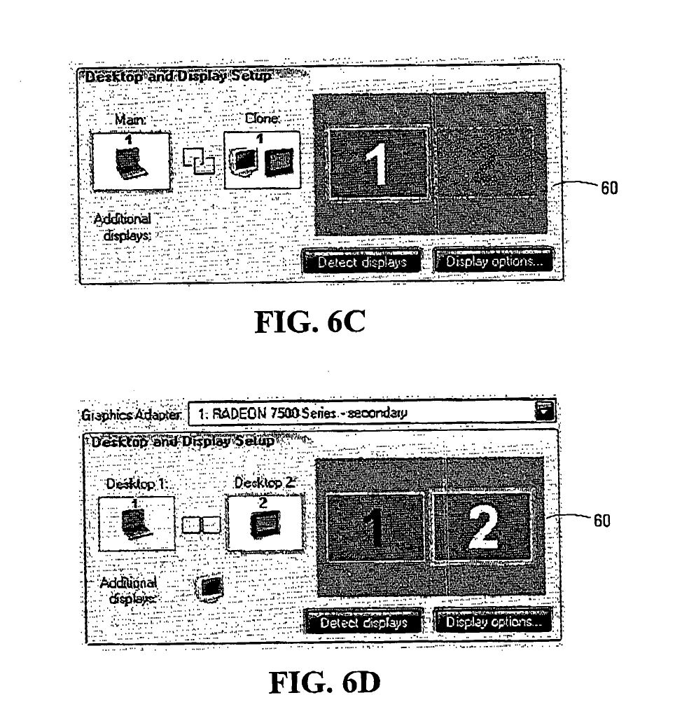

As an example, if adapter 18b is configured with its primary display mapped to an LCD display device, with no secondary display enabled (exemplified by area 60 depicted in FIG. 6A), and a user drags TV icon 70 from region 76 over the secondary display drag-and-drop region 74, software 104 determines permissible configurations with an LCD display device as primary display and a TV as secondary display device for adapter 18b. Software 104, after determining allowable configurations with an LCD display device (primary) and a TV device (secondary) presents a popup dialog offering the following choices upon release of the mouse button (assuming these are valid for adapter 18b):
Extend Main onto TV
Stretch Main horizontally onto TV
Stretch Main vertically onto TV
Clone Main with TV

Each selection may be preceded by the graphic symbol corresponding to icon 80 that depicts that desktop mode (ability to do this in software has not been determined yet).

If, for example, in response “Clone Main with TV”, is selected, then the adapter mode will change from single display to clone mode (upon clicking APPLY button 82), with the LCD display device as primary (now labeled “Main”), and the TV as secondary (now labeled “Clone”) as illustrated in FIG. 6B. The attached TV (i.e. display device 20d) will now have the focus until another device is selected. Icon 80 between regions 72 and 74 will change to indicate that the desktop mode is clone mode.

As a further example, once adapter 18b is in clone mode as exemplified in FIG. 6B above, a user may drag the additional analog display icon from region 76 over secondary display drag-and-drop region 74. As a consequence, the following choices (assumed to be valid) would be presented by software 104:
Swap Clone with Analog Display2
Double-up Clone with Analog Display2

Now if “Double-up Clone with Analog Display2”, is selected, adapter 18b would still be in clone mode, with the LCD display device as primary (labeled “Main”) and the TV and analog display mapped as secondary (labeled “Clone”), as illustrated in FIG. 6C. Hence, icon 80 between regions 72 and 74 would not change.

As a further example, if a user drags the analog display icon 70 directly from secondary mapping region 74 to primary mapping region 72 in the window of FIG. 6B, a popup dialog will offer the following choices (assumed to be valid):
Swap Main with Analog Display2
Double-up Main with Analog Display2

Thus, as noted, display devices 20 may be mapped to adapters 18, by dragging and dropping icons representing the display devices to or from regions 72, 74. Additionally, right clicking on icons 70 in regions 72 or 74 or in area 76 allows for configuration of the device represented by the icon.

For example, right-clicking on an LCD icon that is mapped to the primary drag-and-drop region 72, causes a popup menu to offer the following, possible choices (assumed to be valid):

```
Swap Main with [symbol] TV
        analog display
Extend Main onto [symbol] TV
          analog display
Clone Main with [symbol] TV
        analog display
Stretch Main horizontally onto [symbol] TV
              analog display
Stretch Main vertically onto [symbol] TV
            analog display
Rotate [symbol] Standard Landscape (0°)
    Right (90°)
    Inverted Landscape (180°)
    Left (270°)
Disable
Device properties . . .
```

The depicted arrows indicate that a further submenu is provided from the menu. As will be appreciated, right-clicking on the Main display provides submenus affecting desktop modes that would not be presented if the user's intentions were unambiguous, based on available configuration and options.

In any event, the Rotate submenu presents allowable display orientations, depending on available bandwidth and current mode, with a checkmark beside the currently selected mode (e.g., ✓Standard Landscape (0°)). If the rotated mode is not permissible (due to bandwidth or other limitations), it is grayed out in the submenu.

As exemplified, “Disable” is not an option if there is only one active graphics adapter. This prevents a user from disabling the last active display device.

As a further example, using the new desktop mode, right-licking on either the icon in either region 72, 74 will cause software 104 to offer the following choices (all assumed to be valid):
Swap Main with Clone
Extend Main onto TV (refers to device name, since this is changing the desktop mode)
Stretch Main horizontally onto TV
Stretch Main vertically onto TV

And additionally for the specific device (i.e., may only affect device clicked on, except that rotation would affect cloned and doubled-up displays equally):

```
Rotate [symbol] Standard Landscape (0°)
    Right (90°)
    Inverted Landscape (180°)
    Left (270°)
Device properties . . .
Disable [LCD panel/TV] (if Main is disabled, Clone becomes Main)
```

Further, with “additional displays”, such as the analog monitor in this example, the menu options for the specific device clicked on would include (assumed to be valid):
Swap with [analog display]
Double-up with [analog display]

For displays that are doubled-up (single-display path clone), right-clicking on one of these displays presents the following options:

Disable [specific device]
Device properties for [symbol] [specific device]

If, in response, the user chose, “Extend Main onto TV” labels above primary and secondary regions 72, 74 would change to “Desktop 1” and “Desktop 2”, and the focus would be on the TV (Desktop 2). Icon 80 between regions 72 and 74 would change to one that represents extended desktop mode. Note that, to the operating system, it appears that another adapter has been activated. In the desktop arrangement window 58, rectangle 2 would be activated, and could be dragged to a new position, if desired.

Using this new desktop mode as an example, right-clicking either icon in region 72 or 74 would cause software 104 to present a popup menu offering the following choices (assumed to be valid):
Swap displays
Clone Desktop 1 onto TV (refers to device name, since this is changing the desktop mode)
Stretch Desktop 1 horizontally onto TV
Stretch Desktop 1 vertically onto TV

And additionally for the specific device clicked (i.e., may only affect that device)

```
Rotate [symbol] Standard Landscape (0°)
    Right (90°)
    Inverted Landscape (180°)
    Left (270°)
Device properties . . .
Disable [LCD panel/TV]
```

Further, if there were “additional displays”, such as the analog monitor in this example, the menu options for the specific device clicked on would include (if valid):
Swap with [analog display]
Double-up with [analog display]

Again, to disable a mapped display device 20, a user could simply drag the display icon 70 in drag-and-drop region 72 or 74 to the additional available displays area, Dragging the only icon representing the primary display device to the “additional displays” area, causes the secondary display device to become primary. However, with no secondary display device and with one active graphics adapter, the action is not allowed (the last display device cannot be disabled).

As noted, a selected display device is visually highlighted in window 58 by a border and change of contrast. The adapter 18 interconnected with this device is controlled by area 60. On computing devices with two or more adapters, additional display devices 20 connected to this adapter will similarly be highlighted (e.g. large white numbers). Settings area 64 confirms which display device 20 is currently selected, and allows this display device 20 to be configured.

Settings area 64 contains controls for adjusting display settings such as resolution, desktop area, refresh rate, colour depth, and orientation for individual display devices 20. In the example GUI 50, these settings are controlled using list boxes. Depending on the selected desktop mode some changes may affect one or more display devices, as outlined below.

Specifically, for single display and extended desktop modes, list box 90 provides a description of the display device that is currently in focus (i.e., selected). Consequently the resolution, refresh rate, colour depth, and orientation of the selected display (and only the selected display) can be set with the appropriate controls in list boxes 92, 94, 96 and 98.

Where possible, software 104 obtains the description in list box 90 from the EDID for the attached device, as provided by operating system 116—for example, “Compaq V700™ (Desktop 1)”, where the Desktop number (in the case of an extended desktop) corresponds to the number that appears on the selected rectangle in the desktop arrangement window 58. If no EDID is available, software 104 substitutes a generic term (such as “Analog monitor”).

For other adapter modes including doubling-up (single display-path clone), box 90 will read “Multiple displays” followed by the current desktop mode in parenthesis—for example, “Multiple displays (clone mode)” or “Multiple displays (doubled-up mode)”. This indicates that the resolution, refresh rate, colour depth, and orientation controls will affect more than one display device, as outlined in the next sections.

List box 92 displays the current desktop area (resolution settings) for the selected display, in the form horizontal by vertical pixel count. For dual and single display path clone modes, this setting affects all cloned displays on the selected adapter, since cloned displays show the same frame buffer image. For horizontal and vertical stretch modes, this settings is the combined desktop area (for example, 2048×768) of both displays on the selected adapter, since to the operating system 116 both displays look like one large desktop (either stretched or stacked).

List box 94 selects the current colour settings (in bits per pixel) for the selected display. Example colour quality are: Lowest (8 bit); Medium (16 bit); Highest (32 bit). The colour setting in list box 94 affects all displays operating in clone mode and horizontal and vertical stretch modes. For extended desktop mode, list box 94 affects the selected display only.

Depending on desktop mode, there is either one or multiple list boxes 96 for selecting the current refresh rates of the selected display device(s). For single display and extended desktop modes, there is one refresh rate list box 96 for setting the refresh of the selected display. Additional list box(es) are hidden.

In clone mode and horizontal and vertical stretch modes, there are two list boxes 96: one is labelled “Refresh rate—Main” for setting the refresh rate of the display mapped to the primary display path, and the other list box is labelled “Refresh rate—clone”, “Refresh rate—rightmost”, or “Refresh rate—lower” (as appropriate) for setting the refresh rate of the display mapped to the secondary display path.

For doubled-up mode, both devices on the same display path have the same refresh rate; therefore, the least-capable display device limits the available list of refresh rates.

Depending on the desktop mode, a further list box 98 is available for selecting the current orientation (or “rotation”) of the selected display(s). The orientation options are Standard Landscape (0°)—this is the default angle; Rotate Right (90°); Inverted Landscape (180°); Rotate Left (270°).

Rotation typically requires an additional video buffer equal to the settings for the rotated display. Consequently, on systems with limited graphics memory or bandwidth and where large desktop modes have been selected, this might restrict the modes for which rotation can be supported. This restriction would result in fewer choices being available in the dropdown list box 98. Because of the additional resources required, performance may be affected in rotated modes.

In extended desktop mode, the selected display device can be rotated independent of the other display(s), provided there is sufficient memory to perform rotation. In single display path (doubled-up) and dual-display path clone modes, rotation will affect all cloned displays.

In the depicted embodiment, rotation is not supported in horizontal or vertical stretch modes. In either mode, the Orientation list box 98 is grayed out, showing “Standard Landscape (0°)” selected (the default angle). When a user has finished making selections or changing display mappings, they may click APPLY button 82 to save the new settings.

Again, user interaction changing list boxes 90, 92, 94, 96 or 98 will cause software 104 to apply changes to the respective adapter 116 once APPLY button 82 is pressed.

As will now be appreciated, software 104 and GUI 50 allow users to control mappings and other features of adapters 18 without directly exposing the technical details of the hardware. Thus, users need not have any concept of “display paths”. Instead, users may appreciate that each display will behave somewhat differently, depending on how it is mapped, and what mode is being used.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. In a computing device, a method of configuring a graphics adapter, comprising:
presenting a graphical user interface including first and second drag-and-drop regions;
populating said first and second drag-and-drop regions with icons reflecting display devices interconnected with said graphics adapter, and active, with said first drag-and-drop region reflecting a first display device;
presenting a plurality of additional icons, each additional icon representing an additional display device interconnected with said graphics adapter;
sensing interaction of a user dragging-and-dropping a selected one of said plurality of additional icons into said second drag-and-drop region;
in response to said dragging-and-dropping, determining allowable configurations of said graphics adapter with said first display device active and a second display device as represented by said selected one of said plurality of additional icons, active.

2. The method of claim 1, further comprising presenting said user with a plurality of choices for said graphics adapter, each of said choices reflecting an allowable configuration of said graphics adapter with said first display device active and a second display device as represented by said selected one of said plurality of additional icons, active.

3. The method of claim 2, wherein said graphics adapter comprises first and second display paths each to drive at least one display device, and wherein one of said choices allows activation of said first and second display devices to present video from a single one of said display paths.

4. The method of claim 2, further comprising receiving input reflecting one of said choices made by said user, and configuring said adapter in accordance with said one of said choices.

5. The method of claim 4, further comprising presenting an icon between said first and second drag-and-drop regions reflecting the relationship between said first and second display devices.

6. The method of claim 5, wherein said first and second display devices each comprise one of an LCD panel, an analog monitor, a television, a projector, and a digital flat panel.

7. The method of claim 1, further comprising sensing mouse action by said user on said first drag-and-drop region and responsive thereto presenting to said user a plurality of allowable configuration options for said first display device.

8. The method of claim 1, further comprising sensing a user mouse action on said second drag-and-drop regions and responsive thereto presenting to said user a plurality of allowable configuration options for said second display device.

9. The method of claim 1, wherein said graphical user interface further comprises a display control area for selecting one of said display devices and configuring output provided by said graphics adapter on said one of said display devices selected in said display control area.

10. A computing device comprising at least two display devices interconnected with a graphics adapter, and a graphical user interface for configuring said graphics adapter, said graphical user interface comprising:
an adapter control area, including first and second drag-and-drop regions populated with icons reflecting display devices interconnected with said graphics adapter, and active, with said first drag-and-drop region reflecting a first display device;
a plurality of additional icons, each additional icon representing an additional display device interconnected with said graphics adapter;
said first and second drag-and-drop region responsive to a user dragging-and-dropping a selected one of said plurality of additional icons into said first or second drag-and-drop region, to re-configure said adapter to provide outputs to said display devices, as represented by icons dragged-and-dropped from said additional icons in said first and second drag-and-drop regions.

11. Computer readable medium storing computer software that when loaded at a computing device, adapts said computing device to perform the method of claim 1.
